(19) United States
(12) Patent Application Publication
(10) Pub. No.: US 2006/0181526 A1
(43) Pub. Date: Aug. 17, 2006

(54) Display driver

(75) Inventor: Yusuke Ota, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/352,622

(22) Filed: Feb. 13, 2006

(30) Foreign Application Priority Data
Feb. 16, 2005 (JP) 2005-038981

(51) Int. Cl. G09G 5/00

(52) U.S. Cl. 345/204

(57) ABSTRACT

A display driver including: a hold circuit; a D/A converter converting display data from the hold circuit; and an output selector receiving a gray scale voltage based on output of the converter into a first input terminal and outputting a drive voltage to a drive voltage output terminal, the hold circuit including first to n-th latch circuits. In normal operations, the hold circuit outputs data latched in the latch circuits to the converter. In test operations, the hold circuit serially outputs data latched in the latch circuits as serial output data from the n-th latch circuit. The output selector has a second input terminal receiving the serial output data, outputs to the drive voltage output terminal the gray scale voltage inputted into the first input terminal in normal operations, and a voltage based on the serial output data from the hold circuit into the second input terminal in test operations.

### RELATED APPLICATIONS

This application claims priority to Japanese-Patent Application No. 2005-038981 filed Feb. 16, 2005 which is hereby expressly incorporated by reference herein in its entirety.

### BACKGROUND OF THE INVENTION

1. Technical Field

The invention relates to a display driver.

2. Related Art

An inspection such as confirmation of operations for shipping a product is typically conducted for a display driver for driving a display panel. For example, when inspecting a display driver for driving a TFT panel, as an inspection item, a drive voltage outputted from the display driver is inspected. In this case, since the drive voltage outputted from the display driver of a product is analog, its drive voltage is subjected to one A/D conversion, and the inspection is conducted based on converted digital data.

On the other hand, display drivers meeting demands of displaying high resolution and high gray scale are beginning to be widely used. For example, a display driver driving a TFT panel capable of displaying high gray scale outputs a plurality of types of drive voltages corresponding to the number of gray scales of its TFT panel.

However, as the number of gray scales increases, the corresponding types of voltage increase, while accuracy is required in subjecting its drive voltage to A/D conversion. This hampers reduction of manufacturing cost of the product. Further, the time required in making the A/D conversion also hampers reduction of the manufacturing cost.

Further, a problem occurs if there are more types of drive voltage. It becomes difficult to accurately make the A/D conversion of that drive voltage, thus making it impossible to carry out an inspection of high accuracy as well.

Moreover, the inspection referenced above causes another problem which makes it impossible to conduct an inspection of a logic circuit part of a display driver at the time of product inspection.

JP-A-6-235753 is one example describing the related art.

### SUMMARY

An advantage of some aspects of the invention is to enhance the accuracy of inspection and to provide a display driver which can shorten inspection time.

According to a first aspect of the invention, a display driver includes: a hold circuit holding and outputting display data of at least one pixel; a D/A converter which carries out D/A conversion of display data outputted from the hold circuit; and an output selector in which a gray scale voltage based on an output of the D/A converter is inputted into a first input terminal thereof and outputs a drive voltage to a drive voltage output terminal, wherein the hold circuit includes first to n-th latch circuits (n being a natural number greater than 2), whereby, in a normal operation mode, the hold circuit outputs to the D/A converter data which was latched in the first to the n-th latch circuits, while, in a test mode for carrying out an inspection of the display data, the hold circuit serially outputs the data latched in the first to the n-th latch circuits as serial output data from an output of the n-th latch circuit; the output selector having a second input terminal receiving the serial output data outputted from the n-th latch circuit; outputting to the drive voltage output terminal the gray scale voltage inputted into the first input terminal in the normal operation mode, while outputting to the drive voltage output terminal, in the test mode, a voltage based on the serial output data to be inputted from the hold circuit into the second input terminal.

According to the invention, it is possible to serially output one-pixel display data from the drive voltage output terminal in the test mode inspecting the display driver. As such, when determining an agreement with a test pattern in the test mode, it is possible to determine an agreement between one digital data and another, thereby enabling the accuracy of inspection to be improved and inspection time to be shortened.

Further, according to a second aspect of the invention, the output selector outputs a gray scale voltage, which was inputted into the first input terminal, to the drive voltage output terminal, once an analog output enable signal is set active, while outputting a voltage based on the voltage inputted into the second input terminal to the drive voltage output terminal, once a digital output enable signal is set active.

It may also be arranged such that in the normal operation mode, the analog output enable signal is set active and the digital output enable signal is set non-active, while in the test mode to conduct the display data inspection, the analog output enable signal is set non-active and the digital output enable signal is set active.

This enables display data to be serially outputted from the drive voltage output terminal in the test mode. Further, in the normal operation mode, it can be set such that the drive voltage will not be outputted from the drive voltage output terminal.

Still further, according to a third aspect of the invention, the output selector includes: a p-type transistor set up between an output node connected to the drive voltage output terminal and a first power source; and an n-type transistor set up between a second power source at a lower voltage than the first power source and the output node, wherein, if the digital output enable signal is set active, upon inputting a first level signal into the second input terminal, the p-type transistor assumes an on state and the n-type transistor assumes an off state, whereby through the output node, the drive voltage output terminal is electrically connected to the first power source such that if a second level signal different from the first level is inputted into the second input terminal, the p-type transistor assumes the off state and the n-type transistor assumes the on state, whereupon the drive voltage output terminal may be arranged to be electrically connected to the second power source through the output node.

This enables a voltage based on data inputted into the second input terminal to be outputted from the drive voltage output terminal. Further, if the first input terminal is connected to the drive voltage output terminal, the output node to which the p-type transistor and the n-type transistor are connected can be set at a high impedance state, hence, it may be arranged such that there will be no influence from data inputted into the second input terminal.

Further, according to a fourth aspect of the invention, a digital signal output line is set up between the output selector and an output terminal of the n-th latch circuit, the first to the n-th latch circuits of the hold circuit store data of a first to an n-th bit of the display data, and the hold circuit outputs to the output selector the display data latched in the first to the n-th latch circuits based on a scan enable signal through the D/A converter or the digital signal output line, whereupon, if the scan enable signal is set non-active, data of the first to the n-th bit held in the first to the n-th latch circuits are outputted to the D/A converter through respectively different output lines, while, if the scan enable signal is set active, the data of the first to the n-th bit may be arranged to be outputted, as the serial output data, from the output terminal of the n-th latch circuit to the digital signal output line.

This enables data latched in each latch circuit of the hold circuit to be serially outputted to the second input terminal of the output selector.

Further, according to a fifth aspect of the invention, the hold circuit includes first to (n−1)-th scan switch circuits: a k-th (k being a natural number greater than 1) scan switch circuit of the first to the (n−1)-th scan switch circuits receives an output from the k-th latch circuit of the first to the nth latch circuits as well as data of the (k+1)-th bit data of the display data, wherein, if the scan enable signal is set active, the output of the k-th latch circuit is outputted to the (k+1)-th latch circuit, while, if the scan enable signal is set non-active, the (k+1) bit data may be arranged to be outputted to the (k+1)-th latch circuit.

This enables data latched in each latch circuit to be serially outputted from the hold circuit in the test mode.

According to a sixth aspect of the invention, if a voltage outputted from the drive voltage output terminal is made to correspond to a digital gray scale display of the display panel in the normal operation mode, the hold circuit outputs the data latched in the first to the n-th latch circuits to the D/A converter, while from the drive voltage output terminal, the output selector may be arranged to output a voltage based on the n-th bit data which was supplied to the second input terminal through the digital output line from the n-th latch circuit.

According to a seventh aspect of the invention, if the voltage outputted from the drive voltage output terminal is made to correspond to the digital gray scale display of the display panel, in the normal operation mode, the digital input enable signal to be inputted into the output selector is set active, while the scan enable signal of the hold circuit is set non-active. The output selector may be arranged so as to output the voltage based on the n-th bit data, which was supplied from the n-th latch circuit through the digital output line, from the drive voltage output terminal.

According to an eighth aspect of the invention, the display driver includes: a hold circuit holding and outputting display data of at least one-pixel; a mode selector, upon receiving display data outputted from the hold circuit, outputting by changing over an output channel of the display data corresponding to the normal operation mode or the test mode for inspecting the display data; and the D/A converter equipped with the first to the n-th (n being a natural number greater than 2) D/A converter input terminals, to which the first to the n-th bit data of the display data outputted from the mode selector are inputted, converting the display data inputted through the first to the n-th D/A converter input terminals, wherein the hold circuit includes the first to the n-th (n being a natural number greater than 2) latch circuits storing data of the first to the n-th bit data, whereupon the hold circuit, in the normal operation mode, outputs to the mode selector the data of the first to the n-th bit data latched by the first to the n-th latch circuits through a different output line per latch circuit, while the hold circuit, in the test mode inspecting the display data, serially outputting to the mode selector the first to the n-th bit data latched by the first to the n-th latch circuits as serial data; the mode selector, in the normal operation mode, outputting the first to the n-th bit data of the display data, which were outputted from the hold circuit, to the first to the n-th D/A converter input terminals of the D/A converter, and, in the test mode, outputting the serial output data outputted from the hold circuit, to the first to the n-th D/A converter input terminals of the D/A converter.

According to the invention, in the test mode inspecting the display data, since the display data to be serially outputted from the hold circuit is inputted through the mode selector into each input terminal of the D/A converter in the same way, a voltage corresponding to each bit of the display data can be outputted from the drive voltage output terminal. By detecting this serially outputted voltage, it is possible to read the data of each bit data of the display data, so that when determining the agreement with a test pattern in the test mode, determination of the agreement between the digital data can be made, thus enabling inspection accuracy to improve and inspection time to shorten.

According to a ninth aspect of the invention, the mode selector includes: first to n-th mode selector input terminals, to which the display data is inputted from the hold circuit; and the first to the n-th mode selector output terminals to output the display data to the first-the n-th D/A converter input terminals of the D/A converter, wherein, in the test mode for inspecting the display data, the mode selector, upon receiving the digital output enable signal which is set active, connects the n-th mode selector input terminal of the first to the n-th mode selector input terminals to receive the output of the n-th latch circuit of the hold circuit electrically to the first to the n-th mode selector output terminals, so that the serial output data from the n-th latch circuit may be arranged to be outputted to the first to the n-th mode selector output terminals.

In the test mode, this enables the serial output data outputting from the n-th latch circuit of the hold circuit to be outputted in common to each input terminal of a D/A converter. Further, in the normal operation mode, each latch circuit output of the hold circuit can be connected to each input terminal corresponding individually to the D/A converter.

Further, according to a tenth aspect of the invention, the mode selector includes first to (n−1)-th mode selector switch circuits, wherein the k-th mode selector switch circuit of the first to the (n−1)-th mode selector switch circuits, upon receiving an output from the k-th latch circuit connected to the k-th mode selector input circuit and an output from the n-th latch circuit connected to the n-th mode selector input circuit, may be arranged so as to output the output from the n-th latch circuit to the k-th mode selector output terminal if the digital output enable signal is set active, while outputting the output from the k-th latch circuit to the k-th mode selector output terminal, if the digital output enable signal is set non-active.

Furthermore, according to an eleventh aspect of the invention, it may be arranged such that the hold circuit outputs to the mode selector the display data latched in the first to the n-th latch circuits based on the scan enable signal, outputting to the mode selector the first to the n-th bit data held in the first to the n-th latch circuits through respectively different output lines, if the scan enable signal is set non-active, while outputting to the mode selector the first to the n-th bit data from the n-th latch circuit output terminal as serial output data.

According to a twelfth aspect of the invention, the hold circuit further includes the first to the (n−1)-th scan switch circuits, wherein it may be arranged such that the k-th (k being a natural number greater than 1) scan switch circuit of the first to the n-th latch circuits, upon receiving an output from the k-th latch circuit of the first to the n-th latch circuits and the (k+1)-th bit data of the display data, outputs the k-th latch circuit to the (k+1)-th latch circuit if the scan enable signal is set active, while outputting the (k+1)-th bit data to the (k+1)-th latch circuit if the scan enable signal is set non-active.

### BRIEF DESCRIPTION OF THE DRAWINGS

The invention will be described with reference to the accompanying drawings, wherein like numbers refer to like elements.

FIG. 1 is a diagram showing a display driver according to a first embodiment.

FIG. 2 is an example of construction of a hold circuit according to a first embodiment and a second embodiment.

FIG. 3 is an example of construction of an output selector of a display driver according to a first embodiment.

FIG. 4 is a timing chart explaining operation of a display driver in normal operation mode according to a first embodiment.

FIG. 5 is a timing chart explaining operation of a display driver in test mode according to a first embodiment.

FIG. 6 is a flow chart showing an inspection flow of a display driver according to a first embodiment.

FIG. 7 is a diagram showing a display driver according to a second embodiment.

FIG. 8 is an example of construction of a mode selector of a display driver according to a second embodiment.

FIG. 9 is a timing chart explaining operation of a display driver in normal operation mode according to a second embodiment.

FIG. 10 is a timing chart explaining operation of a display driver in test mode according to a second embodiment.

FIG. 11 is an example of construction of a comparative example of a display driver according to a first embodiment and a second embodiment.

FIG. 12 is a flow chart showing an inspection flow of a display driver of a comparative example.

### DESCRIPTION OF THE EMBODIMENTS

Embodiments of the invention will be described now with reference to the accompanying drawings. The embodiments to be explained in the following do not limit the content of the invention described in the scope of claims. Further, all the constituent elements to be described below are not necessarily essential constituent features of the invention.

### FIRST EMBODIMENT

Display Driver

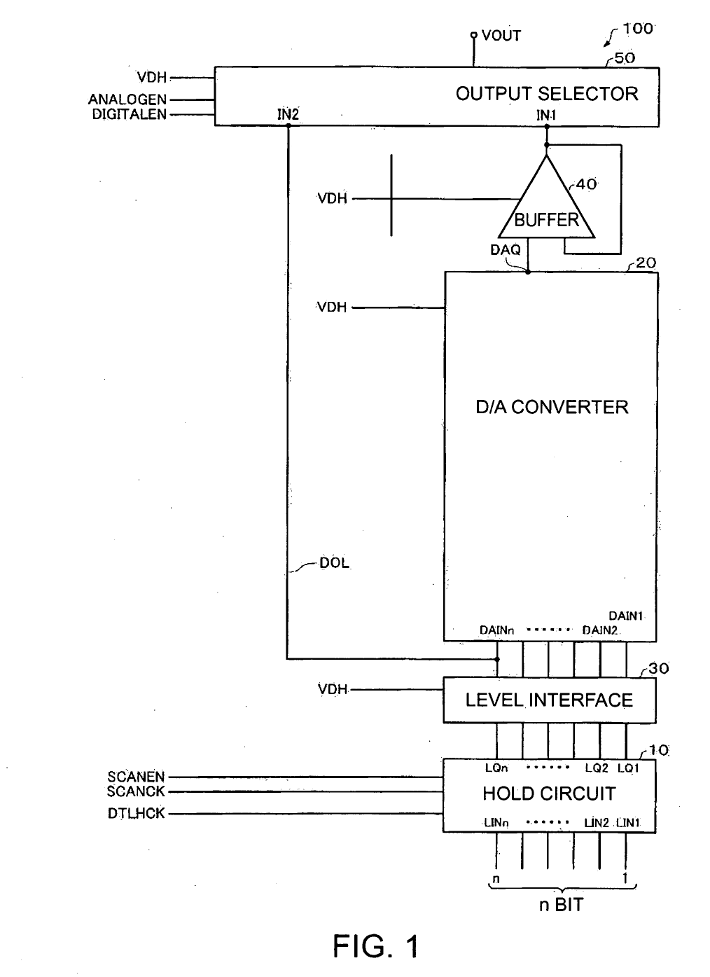

FIG. 1 is a diagram showing a display driver 100 according to a first embodiment. For the sake of simplifying explanation, the display driver 100 is described for a one-pixel portion, but it is not limited to this. When simultaneously driving a plurality of pixels, it suffices to set up a plurality of display drivers 100.

The display driver 100 includes, for example, a hold circuit 10 storing display data of a one-pixel portion, a D/A converter 20 converting the display data, a level interface 30 adjusting an output level of the hold circuit 10, a buffer circuit 40 receiving an output of the D/A converter 20 and an output selector 50 outputting a drive voltage. But it is not limited to this. There is no need for the display driver 100 to include all the above-referenced constituent elements. For example, a construction omitting the level interface 30 and the buffer circuit 40 is possible

The hold circuit 10 includes a plurality of input terminals LIN1 to LINn and a plurality of output terminals LQ1 to LQn, with display data of one pixel being inputted into the plurality of input terminals LIN1 to LINn.

Specifically, each bit data of the n-bit display data is inputted with respect to each input terminal LIN1 to LINn of the hold circuit. For example, a first bit data of the display data is inputted into the input terminal LIN1, a second bit data is inputted into the input terminal LIN2, and an n-th bit data of the display data is inputted into the input terminal LINn.

If a scan enable signal SCANEN is set non-active, the hold circuit 10 holds the n-bit display data inputted into each input terminal LIN1 based on a clock DTLHCK and outputs each bit data of the n-bit display data from each output terminal LQ1 to LQn.

On the other hand, if the scan enable signal SCANEN is set active, the hold circuit 10 serially outputs each bit data of the n-bit display data, for example, from the output terminal LQn. In this case, serial outputting means, for example, that the n-bit data is outputted from the output terminal LQn, then the (n−1)-th bit data is outputted from the output terminal LQn, thereafter, outputting being carried on successively until the first bit data. A series of the n-th to the first bit data outputted by this serial outputting is called the serial output data.

A level interface 30 receives n-bit display data from the hold circuit 10, adjusts the data to a signal level appropriate for the D/A converter 20 in a later stage, and outputs the data to the D/A converter 20. For example, the level interface 30 receives supply of a voltage VDH regarding signal level adjustment. But it is not limited to this.

The level interface 30 receives n-bit display data from each output terminal LQ1 to LQn of the hold circuit 10 through wiring of respectively separate systems. Further, the level interface 30 subjects each bit data of the n-bit display data, which were inputted, to signal level adjustment and outputs such data to a plurality of input terminals DAIN1 to DAINn (in a broad sense, the first to the n-th D/A converter input terminals) through wiring of respectively separate systems.

Specifically, the level interface 30, for example, subjects an output of the output terminal LQ1 of the hold circuit 10 to level adjustment and outputs it to the input terminal DAIN1 of the D/A converter. Likewise, the level interface 30 subjects an output of each output terminal LQ2 to LQn of the hold circuit 10 to level adjustment and outputs each to each input terminal DAIN2 to DAIn of the D/A converter.

Namely, if the first to the n-th bit data of the n-bit display data are outputted from each output terminal LQ1 to LQn of the hold circuit 10, a signal corresponding to each bit of the n-bit display data is inputted into each input terminal DAIN1 to DAINn of the D/A converter 20.

Specifically, for example, a signal corresponding to the first bit data of the n-bit display data is inputted into the input terminal DAIN1, and, for example, a signal corresponding to a second bit data of the n-bit data is inputted into the input terminal DAIN2. Likewise, a signal corresponding to the n-th bit data of the n-bit data is inputted into the input terminal DAINn.

In the embodiment, the level interface 30 may be omitted, and each of the output terminals LQ1 to LQn of the hold circuit 10 may be arranged so as to be connected to each input terminal DAIN1 to DAINn of the D/A converter 20.

The D/A converter 20 performs D/A conversion based on the first to the n-th bit data of the n-bit data inputted into each of the input terminals DAIN1 to DAINn, outputting the gray scale voltage corresponding to the n-bit display data to an output terminal DAQ of the D/A converter 20. It should be noted that although the voltage VDH is supplied to the D/A converter, it is not limited to this.

The buffer circuit 401, upon receiving the gray scale voltage outputted from the output terminal DAQ of the D/A converter 20, outputs it to an input terminal IN1 (in the broad sense, the first input terminal) of the output selector 50. Now, the voltage VDH is supplied to the buffer circuit 40. But it is not limited to this.

The output selector 50 includes the input terminal IN1, an input terminal IN2 (in the broad sense, the second input terminal) and a drive voltage output terminal VOUT. To the input terminal IN2 of the output selector 50, there is connected a digital output line DOL provided between the hold circuit 10 and the output selector 50. Further, the output selector 50, upon receiving an analog output enable signal ANALOGEN and a digital output enable signal DIGITALEN, changes over a voltage to be outputted to the drive voltage output terminal VOUT based on these signals of ANALOGEN and DIGITALEN.

Specifically, if the analog output enable signal ANALOGEN is set active and the digital output enable signal DIGITALEN is set non-active, the output selector 50 outputs the gray scale voltage inputted into the input terminal IN1 to the drive voltage output terminal VOUT.

Conversely, if the analog output enable signal ANALOGEN is set non-active and the digital output enable signal DIGITALEN is set active, the output selector 50 selects the input terminal IN2. This permits a voltage supplied from the digital output line DOL, which is connected to the input terminal IN2, to be outputted from the drive voltage output terminal VOUT.

It should be noted that one end of the digital output line DOL is connected to the input terminal IN2 of the output selector 50, its other end being connected to wiring which connects the input terminal DAINn of the D/A converter 20 to the level interface 30. Namely, a voltage corresponding to data outputted from the output terminal LQn of the hold circuit 10 is inputted into the input terminal IN2 of the output selector 50. By this operation, in the above-referenced case, that is, the case where the output selector 50 selects a voltage to be inputted into the input terminal IN2 as a drive voltage to be outputted from the drive voltage output terminal VOUT, a voltage corresponding to data outputted from the output terminal LQn of the hold circuit 10 is outputted from the drive voltage output terminal VOUT.

Now, as described above, from the output terminal LQn of the hold circuit 10, corresponding to the scan enable signal SCANEN to be inputted into the hold circuit 10, either the n-th bit data of the n-bit display data or serial data (in the broad sense, serial output data) of the first to the n-th data of the n-bit display data is outputted.

Namely, in the case where the output selector 50 selects the input terminal IN2, if the scan enable signal SCANEN to be inputted into the hold circuit 10 is set active, a voltage corresponding to each bit data of the n-bit display data is successively outputted from the drive voltage output terminal VOUT.

On the other hand, if the output selector 50 selects the input terminal IN2 and the scan enable signal SCANEN is set non-active, a voltage corresponding to the n-th bit data of the n-bit display data is outputted from the drive voltage output terminal VOUT. In this case, it is effective when coping with a digital gray scale display of the display panel.

In the digital gray scale display, the display panel is driven according to a high level or a low level voltage outputted from the drive voltage output terminal VOUT. For example, if one dot of the display panel is constituted by three pixels of an R pixel, a G pixel, and a B pixel, since, in the digital gray scale display, two gray scales can be expressed, a color display of eight gray scales is made.

In the embodiment, in the normal operation mode, it is possible to cope with an analog gray scale display or a digital gray scale display of the display panel by setting the digital output signal DIGITALEN and the analog output signal ANALOGEN.

Note that the digital output line DOL is not limited to the above-referenced construction. What is desired is that a signal corresponding to data outputted from the output terminal LQn of the hold circuit 10 is inputted into the input terminal IN2 of the output selector 50. For example, the other end of the digital output line DOL may be arranged to be connected to the output terminal LQn of the hold circuit 10.

Further, if the analog output signal ANALOGEN and the digital output signal DIGITALEN are set non-active, the output selector 50 puts both the input terminals IN1 and IN2 as non-select, outputting no voltage from the drive voltage output terminal VOUT. In this case, for example, the drive voltage output terminal VOUT may be set at a high impedance state. Namely, the display driver 100 according to the embodiment can be arranged so as not to output the gray scale voltage generated through D/A conversion to the display panel.

In the following is shown a construction example of a display driver when one-pixel display data includes, for example, 6-bit (in the broad sense, n-bit (n being a natural number) data and 6-bit data which is one-pixel display data. But it is not limited to this.

Hold Circuit

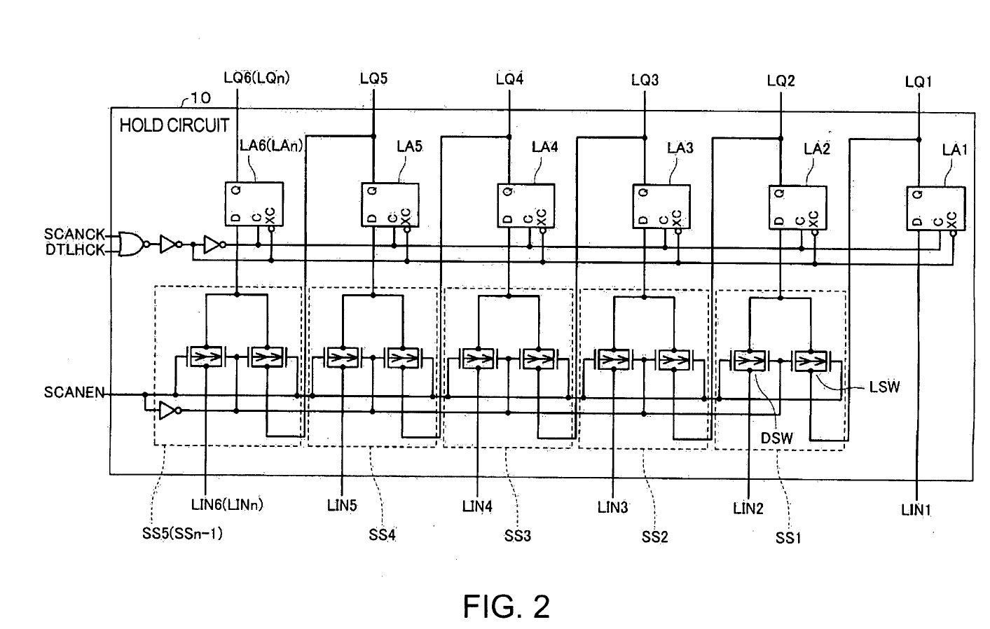

FIG. 2 is a diagram showing a construction example of the hold circuit 10. The hold circuit 10 includes first to n-th latch circuits LA1 to LAn and first to (n−1)-th scan switch circuits SS1 to SS(n−1). It should be noted that in FIG. 2, a construction example of a case of holding 6-bit display data is shown. The hold circuit 10 includes six latch circuits LA1 to LA6 and five (6−1=5) scan switch circuits SS1 to SS5.

An output Q of each of the latch circuits LA 1 to LA6 is connected to the output terminals LQ1 to LQ6 of the hold circuit 10. The input terminal LIN1 of the hold circuit 10 is connected to an input D of the latch circuit LA1. An output of each of the scan switch circuits SS1 to SS5 is connected to the input D of each of the remaining latch circuits LA2 to LA6. For example, the output of the scan switch circuit SS1 is connected to the input D of the latch circuit LA2, and, for example, an output of the scan switch circuit SS5 is connected to the output D of the latch circuit LA6.

To a clock input C of each of the latch circuits LA1 to LA56 is inputted a clock based on a scan clock SCANCK or the clock DTLHCK, and to an inverted clock input XC of each of the latch circuits LA1 to LA6 is inputted an inverted signal of a signal input into the clock input C. By this operation, each of the latch circuits LA1 to LA6 carries out latching data inputted into the input D of each of the latch circuits LA1 to LA6 and outputting of data from the output Q of each of the latch circuits LA1 to LA6.

It should be noted that each of the latch circuits LA1 to LA6 is constituted by, for example, a delay flip-flop (D-FF).

The output Q of a k-th latch circuit LAk (k being a natural number below n) of each of the latch circuits LA1 to LA6 is connected to a k-th scan switch circuit SSk of each of the switches for scan SS1 to SSn−1. For example, the output Q of the third latch circuit LA3 is connected to a+++ third scan switch circuit SS3.

Further, each of the scan switch circuits SS1 to SS5 is connected to each of the input terminals LIN2 to LIN6 of the hold circuit 10. For example, a first scan switch circuit SS1 is connected to the input terminal LIN2 of the hold circuit 10. It should be noted that the k-th latch circuit LAk and the k-th scan switch circuit SSk show the latch circuit LAk and the scan switch circuit SS1 when k=1, while showing the latch circuit LA5 and the scan switch circuit SS5 when k=5.

Further, each of the scan switch circuits SS1 to SS includes switches DSW and LSW which are subject to on and off control based on the scan enable signal SCANEN. For example, the switch DSW for the k-th scan switch circuit SSk is connected to outputs of the input terminal LINk of the hold circuit 10 and the k-th scan switch circuit SSk based on the scan enable signal SCANEN. By this operation, the input terminal LINk of the hold circuit 10 is connected to the input D of a (k+1)-th latch circuit LAk+1.

Further, for example, the switch LSW of the k-th scan switch circuit SSk is connected to an output Q of the k-th latch circuit LAk and the output of the k-th scan switch circuit SSk based on the scan enable signal SCANEN. By this operation, the output of the k-th latch circuit LAk is connected to the input D of the k-th latch circuit LAk+1. It should be noted that the input terminal LINk shows the input terminal LIN 1 when k=1, and the input terminal LIN5 when k=5.

In the construction such as referenced above, when the scan enable signal SCANEN is set active, the switch LSW of the k-th scan switch circuit SSk turns on and the switch DSW of the scan switch circuit SSk turns off, so that the output Q of the k-th latch circuit LAk is connected to the input D of the (k+1)-th latch circuit LAk+1.

On the other hand, if the scan enable signal SCANEN is set non-active, the switch DSW of the k-th scan switch circuit SSk turns on and the switch LSW of the scan switch circuit SSk turns off and the switch LSW of the scan switch circuit SSk turns off, so that the input terminal LINk of the hold circuit 10 is connected to the input D of the (k+1)-th latch circuit LAk+1.

Namely, the (k+1)-th latch circuit LAk+1 latches data of the output Q of the k-th latch circuit LAk if the scan enable signal SCANEN is active, while latching data inputted into the input terminal LINk of the hold circuit 10 if the scan enable signal SCANEN is set non-active. By this operation, if the scan enable signal SCANEN is set active, it is possible to serially output each bit data of the n-bit data inputted into the hold circuit 10 from the output Q of the latch circuit LA6 (in the broad sense, the n-th latch circuit) which is the latch circuit in the final stage of each of the latch circuits LA1 to LA6.

Further, if the scan enable signal SCANEN is non-active, the hold circuit 10 holds data supplied to the input terminals LIN1 to LIN6 through each of the latch circuit LA1 to LA6 and outputs the data held to the output terminals LQ1 to LQ6.

Output Selector

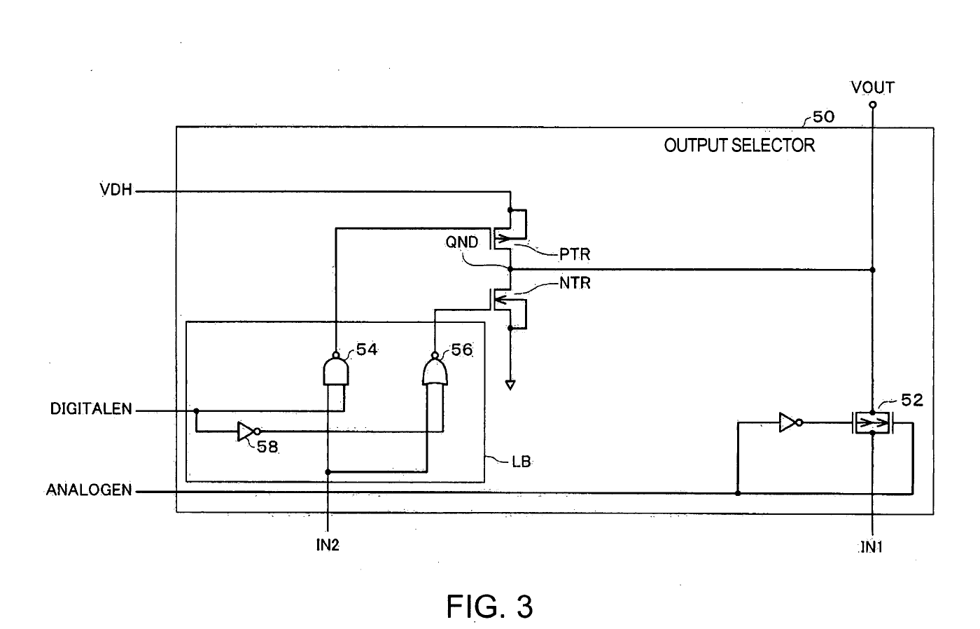

FIG. 3 is a diagram showing a construction example of the output selector 50. The output selector 50 includes a p-type transistor PTR, an n-type transistor NTR, a switch circuit 52 connecting the first input terminal IN1 and the drive voltage output terminal VOUT, and a logic circuit LB.

To a source of the p-type transistor PTR, for example, there is supplied the voltage VDH (in the broad sense, a voltage of a first power source). To a source of the n-type transistor NTR, there is supplied a voltage VSS (in the broad sense, a voltage of a second power source) which is a lower voltage than the voltage VDH. The voltage VSS is, for example, set at a ground level voltage, but it is not limited this.

A drain of each of the transistors PTR and NTR is connected to an output node QND, a voltage of the output node QND is set as a gate of each of the transistors PTR + and NTR is controlled by .the logic circuit LB. For example, when a low level voltage is supplied to the gate of each of the transistors PTR and NTR, the output node is set, at the voltage VDH. Conversely, when a high level voltage is supplied to the gate of each of the transistors PTR and NTR, the output node is set at the voltage VSS.

If the digital output enable signal DIGITALEN is set active, and, for example, if a voltage level to be inputted into the input terminal IN2 is a first level, the logic circuit LV supplies a low level voltage to the gate of each of the transistors PTR and NTR. Further, if the digital output enable signal DIGITALEN is set active, and, for example, if a voltage level to be inputted into the input terminal IN2 is a second level different from the first level, a high level voltage is supplied to the gate of each of the transistors PTR and NTR.

Namely, if the digital output enable signal DIGITALEN is set active, the logic circuit LB changes the voltage level to output to the gate of each of the transistors PTR and NTR corresponding to a changeover of the voltage level to be inputted into the second input terminal IN2. If the digital output enable signal DIGITALEN is set non-active, no voltage is supplied to the gate of each of the transistors PTR and NTR. In this case, for example, the logic circuit LB may be arranged to set the gate of each of the transistors PTR and NTR at the high impedance state. By this operation, the voltage level of the output node QND is not affected by the voltage inputted into the input terminal IN2.

The logic circuit LB includes a NAND circuit 54, a NOR circuit 56, and a NOT circuit 58, while an output of the NAND circuit is connected to a gate of the p-type transistor PTR with an output of the NOR circuit 56 being connected to a gate of the p-type transistor PTR. The NAND circuit 54 is provided with two inputs, into one of which the digital output enable signal DIGITALEN is inputted, the other being connected to the input terminal IN2. The NOT circuit 58 is outputted to the NOR circuit 56 by inverting the digital output enable signal DIGITALEN. The NOR circuit 56 is provided with two inputs, into one of which an output from the NOT circuit 58 is inputted, the other being connected to the input terminal IN2.

If the digital output enable signal DIGITALEN, which is set active, is inputted into the logic circuit LB, a high level voltage is inputted for one input of the NAND circuit 54, while a low level voltage inverted by the NOT circuit 58 is supplied to one input of the NOR circuit 56. At this instant, if a high level voltage is inputted into the input terminal IN2, a high level voltage is inputted into the other input of the NAND circuit 54 and the other input of the NOR circuit 56, while the NAND circuit 54 and the NOR circuit 56 output a low level voltage to the gate of the p-type transistor PTR.

Further, if the low level voltage is inputted into the input terminal IN2, the low level voltage is inputted into the other input of the NAND circuit 54 and the other input of the NOR circuit 56, while the NAND circuit 54 and the NOR circuit 56 output a high level voltage to the p-type transistor PTR.

In this manner, if the digital output enable signal DIGITALEN is set active, the logic circuit LB controls the voltage level of the gate of the source of each of the transistors PTR and NTR corresponding to the changeover of the level of the voltage inputted into the input terminal IN2.

Further, if the digital output enable signal DIGITALEN, which is set non-active, is inputted into the logic circuit LB, the low level voltage is inputted into one input of the NAND circuit 54, while the high level voltage inverted by the NOT circuit 58 is supplied to one input of the NOR circuit 56. At this time, despite the voltage level inputted into the input terminal IN2, the NAND circuit 54 outputs a high level voltage to the gate of the p-type transistor PTR, while, regardless of the voltage level inputted into the input terminal IN2, the NOR circuit 56 outputs a low level voltage to the n-type transistor NTR. By this operation, if the digital output enable signal DIGITALEN is set non-active, regardless of the voltage level inputted into the input terminal IN2, each of the transistors PTR and NTR can be set at the + off state, so that the output node QND can be set at the high impedance state.

Note that the logic circuit LB is not limited to the construction referenced above. If the digital output enable signal DIGITALEN is set active, it is acceptable so long as the logic circuit is so as to change the voltage level outputted to the gate of each of the transistors PTR and NTR corresponding to the changeover of the level of the voltage inputted into the second input terminal IN2.

If the digital output enable signal DIGITALEN is set non-active and the analog output enable signal ANALOGEN is set active, the output node QND is set at the high impedance state, causing the switch circuit 52 to be at an on state. By this operation, there is outputted a gray scale voltage inputted from the drive voltage output terminal VOUT into the input terminal IN1.

Conversely, if the digital output enable signal DIGITAZLEN is set active and the analog output enable signal ANALOGEN is set non-active, there is outputted a level of voltage corresponding to a voltage level which was inputted from the output node QND into the input terminal IN2, and the switch circuit 52 assumes the off state. By this operation, there is outputted a level of voltage corresponding to a voltage inputted from the drive voltage output terminal VOUT into the input terminal IN2.

Further, if the digital output enable signal DIGITALEN and the analog output enable signal ANALOGEN are set non-active, the output node QND is set at the high impedance state, causing the switch circuit 52 to be set at the off state. By this operation, the drive voltage output terminal VOUT is set at the high impedance state. Namely, a case where the display panel is not driven can be set.

Further, the output selector 50 is not limited to the construction referenced above. For example, with two signals of the digital output enable signal DIGITALEN and the analog output enable signal ANALOGEN, a voltage to be outputted from the drive voltage output terminal VOUT is selected. However, these signals may be replaced with one signal to provide for a common construction.

Specifically, the output selector 50 uses a signal made common as the digital output enable signal DIGITALEN so as to provide for a construction in which the signal made common may be inverted for use as the analog output enable signal ANALOGEN.

Operation

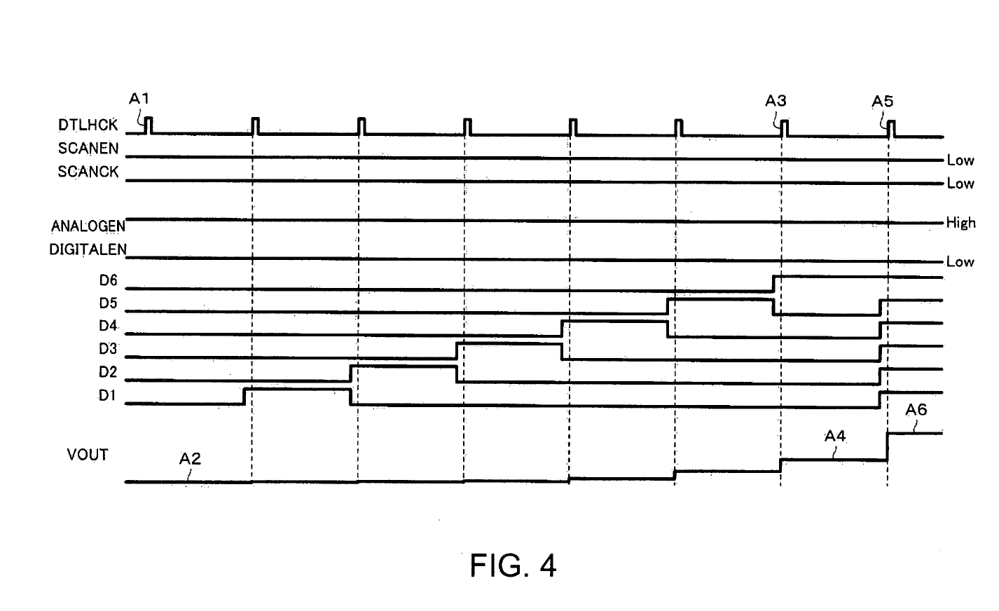

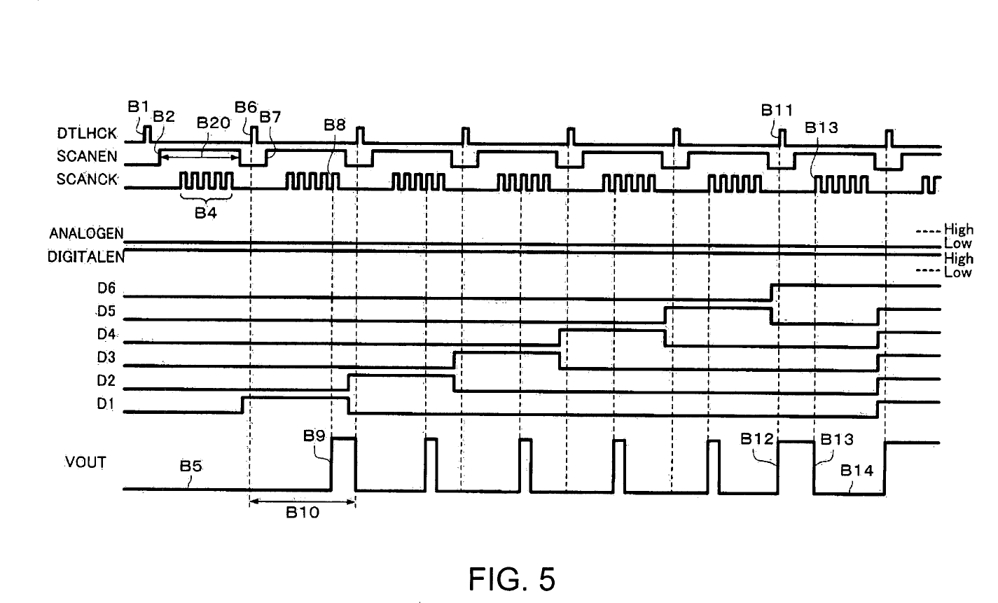

By referring to timing charts in FIG. 4 and FIG. 5, operation of the display driver 100 of the embodiment will be described. FIG. 4 is a timing chart showing the operation in the normal operation mode. In the normal operation mode, the scan enable signal SCANEN to be inputted into the hold circuit 10 is set non-active. Furthermore, in FIG. 4, there is shown a case where the output of the drive voltage output terminal VOUT is made not in digital output but in analog output. Consequently, the analog output enable signal ANALOGEN is set active (for example, high level) and the digital output enable signal DIGITALEN is set non-active (for example, low level). Symbols D1 to D6 indicate the first to the sixth bit data of the 6-bit display data.

Based on a clock DTLHK, the 6-bit display data is inputted into the D/A converter. The D/A converter subjects the inputted display data to D/A conversion and outputs the data. By this operation, the drive voltage is outputted from the drive voltage output terminal VOUT of the output selector 50.

For example, when the clock DTLHCK starts up at a timing shown in A1, since each of the first to the sixth bit data is low level, a drive voltage of a level shown in A2 is outputted from the drive voltage output terminal VOUT.

Further, for example, when the clock DTLHCK starts up at the timing shown in A3, since the first to the fifth bit data D1 to D5 are low level and the sixth bit data D6 is high level, the drive voltage such as the one shown in A4 is outputted. Furthermore, when the clock DTLHCK starts up at the timing shown in A5, since each of the first to the sixth bit data D1 to D6 is high level, a drive voltage of a level shown in A6 is outputted.

In this manner, in the normal operation mode, the drive voltage corresponding to a value of the display data is outputted from the drive voltage output terminal VOUT of the output selector 50.

Next, operation in the test mode will be described with reference to FIG. 5. In the test mode carrying out an inspection of the display driver 100, the digital output enable signal DIGITALEN to be inputted into the output selector 50 is set active, while the analog output enable signal ANALOGEN is set non-active. Further, the scan enable signal SCANEN to be inputted into the hold circuit 10 is, for example, set active as shown in B20, while a one-pixel portion of the 6-bit data is outputted.

For example, the clock DTLHCK starts up at the timing shown in B1 and a voltage corresponding to the sixth bit data D6 is inputted into the input terminal IN2 of the output selector 50 through the digital output line DOL. Then the scan enable signal SCANEN starts up at the timing shown in B2, and as shown in B4, to output the fifth to the first bit data D5 to D1 into the input terminal IN2, the scan clock SCANCK is inputted into the hold circuit 10.

By this operation, from the drive voltage output terminal VOUT, a pulse corresponding to the 6-bit display data is outputted. For example, at the timing shown in B1, since the first to the sixth bit data D1 to D6 are shown in low level, a pulse corresponding to the 6-bit display data, that is, the pulse shown in B5, is outputted from the drive voltage output terminal VOUT.

For example, at the timing shown in B6, the clock DTLHK starts up, and at the timing shown in B7, the scan enable signal SCANEN is set high level. Then, a voltage corresponding to the fifth to the first bit data D5 to D1 is inputted into the input terminal IN2 of the output selector 50 corresponding to the scan clock SCANCK.

At this time, the first bit data D1 is high level and the second to the sixth bit data D2 to D6 are low level, hence, for example, if the scan clock SCANCK starts up at the timing shown in B8, a high level voltage is inputted into the input terminal IN2 through the digital output line DOL. By this operation, a pulse starting up at the timing shown in B9 from the drive voltage output terminal VOUT is outputted.

In this manner, for example, at a period shown in B10, by detecting a pulse starting up at the timing shown in B9 outputted from the drive voltage output terminal VOUT, it is possible to read that of the 6-bit display data, the first bit data D1 is high level and the second to the sixth bit data D2 to D6 are low level. Namely, in the test mode, the content of the display data can be digitally acquired from the drive voltage output terminal VOUT. FIG. 5 may be described a little further. For example, when the clock DTLHK starts up at the timing shown in B1, since the sixth bit data D6 is high level at this time, a high level voltage is inputted into the input terminal IN2 of the output selector 50. Namely, a voltage, which is outputted from the drive voltage output terminal VOUT at the timing shown in B12, starts up. And, when the scan clock SCANCK starts up at the timing shown in B13, the fifth bit data D5 is low level, hence, the output of the drive voltage output terminal VOUT trails at the timing shown in B13. Thereafter, since the fourth to the first bit data D4 to D1 are low level, the output of the drive voltage output terminal VOUT becomes a level shown in B14. Namely, if the sixth bit data is high level and the fifth to the first bit data D5 to D1 are low level, there is outputted, from the drive voltage output terminal VOUT, a pulse which, for example, starts up at the timing of B12 and trails at the timing of B13, settling at a level of B14.

As described above, in the test mode, the 6-bit display data stored in the hold circuit 10 is outputted from the drive voltage output terminal VOUT of the output selector 50 as digital serial data.

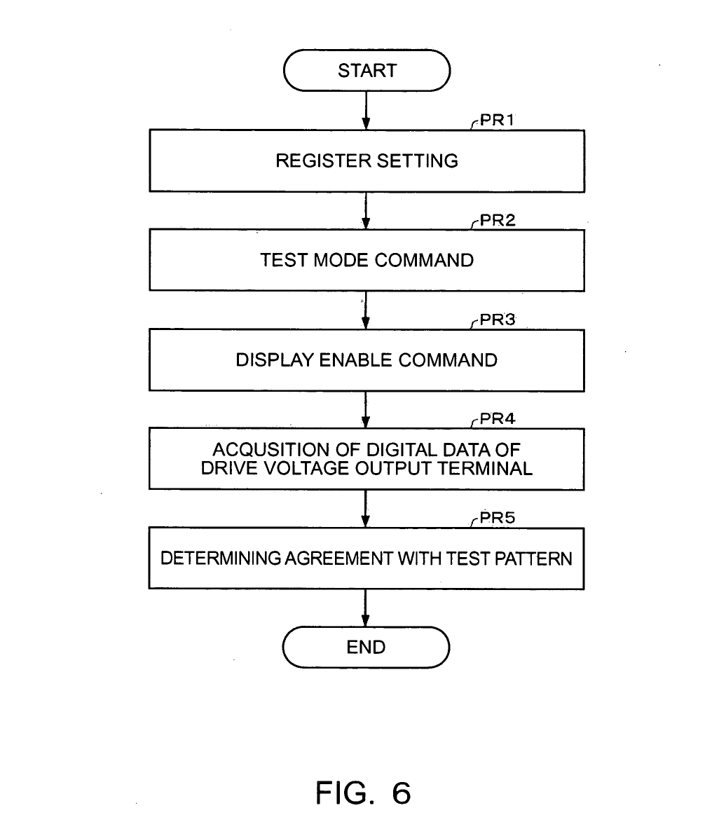

In FIG. 6, there is shown an example of a flow of inspection of the display driver 100 according to the embodiment. In processing PR1, various settings of an internal register of the display driver 100 are carried out. Next, in processing PR2, a command for setting the test mode is sent out to the display driver 100. By this command, inputted into the output selector 50 of the display driver 100 are the analog output enable signal ANALOGEN which was set non-active and the digital output enable signal DIGITALEN which was set active. Moreover, to conduct a test, a test pattern is written in advance into the display memory and the like where the display data is stored. However, this write operation is not limited to processing PR2 but may be carried out by other processing.

Next, in processing PR3, a display enable command is sent out to the display driver 100. By means of the display enable command, for example, from the display memory where the display data is stored, the display data of each pixel is outputted to the hold circuit 10 of the display driver 100. Further, as shown at a timing of FIG. 5, the clock DTLHCK, the scan clock SCANCK. and the scan enable signal SCANEN are inputted into the hold circuit 10, so that digital data of the 6-bit display data is inputted into the input terminal IN2 of the selector 50 through the digital output line DOL. By this operation, the 6-bit display data is outputted from the drive voltage output terminal VOUT of the output selector 50.

Next, in processing PR4, the 6-bit data to be outputted in processing PR3 from the drive voltage output terminal VOUT of the output selector 50 is acquired as digital serial data.

Next, in processing PR5, the 6-bit display data acquired in processing PR4 is compared to a test pattern of display data set in advance and an agreement is determined. By this determination of the agreement, whether or not the display driver 100 operates, for example, according to the design can be determined.

In this manner, the display driver 100 according to the embodiment can inspect the display driver 100 in terms of digital display data, hence, an inspection of high accuracy can be conducted. Note that the above-referenced inspection is an example of the inspection. It is not limited to the display driver 100 of the embodiment.

### SECOND EMBODIMENT

Display Driver

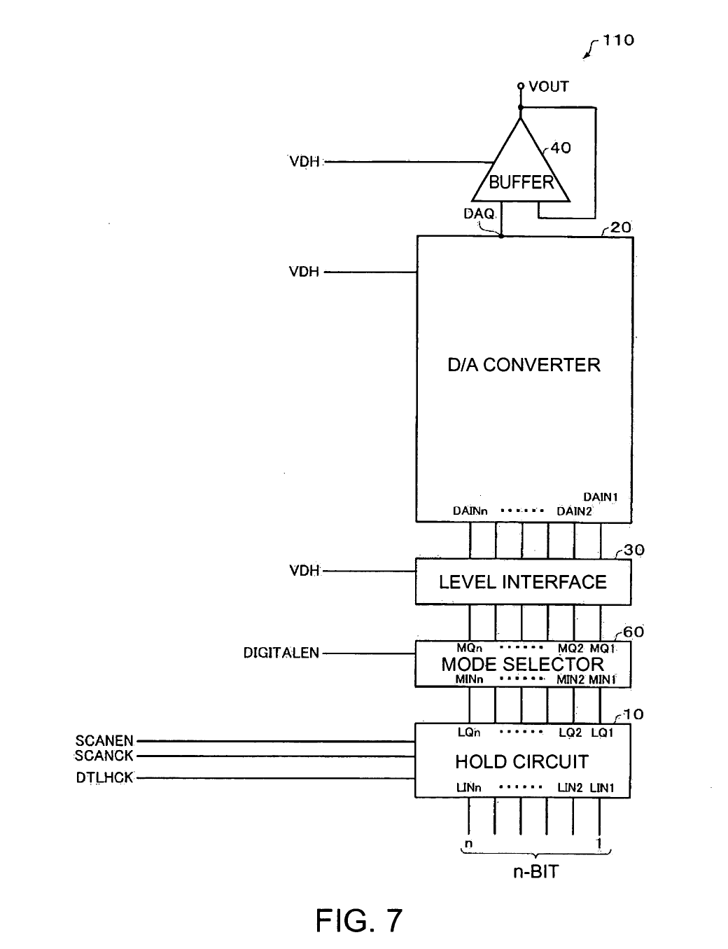

FIG. 7 is a diagram showing a construction example of a display driver 110 according to a second embodiment. The display driver 110 includes a hold circuit 10, a D/A converter 20, a level interface 30, a buffer 40 and a mode selector 60. A major difference between the display driver 110 and the display driver of FIG. 1 is that the display driver 110 includes the mode selector 60.

Now, the digital output line DOL and the output selector 50 of the display driver 100 in FIG. 1 are not illustrated in the display driver 110 of FIG. 7. However, a construction including these is possible in the display driver 110. Further, the display driver 110 is not limited to the above-referenced construction. For example, a construction omitting the level interface 30 and the buffer 40 will suffice. The hold circuit 10, the D/A converter 20, and the level interface 30 are of the same construction as those illustrated in the display driver 100 of FIG. 1. Moreover, in the embodiment, there are illustrations and description of a case where the display data is in 6 bits as a construction example. But it is not limited to this.

The mode selector 60 includes a plurality of input terminals MIN1 to MINn (in the broad sense, the first to the n-th mode selector input terminals) and a plurality of output terminals MQ1 to MQn (in the broad sense, the first to the n-th mode selector output terminals). Each of the input terminals MIN1 to MINn is connected to each of the output terminals MQ1 to MQn of the hold circuit 10. The mode selector 60, based on the digital enable signal DIGITALEN, changes over connections between each of the input terminal MIN1 and MIN2 between each of the output terminals MQ1 to MQn.

Specifically, if the digital enable signal DIGITALEN is set non-active, each of the input terminal MIN1 to MIN2 and each of the output terminal MQ1 to MQn are connected 1 to 1. In this case, for example, the input terminal MIN1 is connected to the output terminal MQ1, and, for example, the input terminal MINn is connected to the output terminal MQn. On the other hand, if the digital enable signal DIGITALEN is set active, the input terminal MINn is connected to each of the output terminals MQ1 to MQn. For example, the input terminal MIN1 is connected to the output terminal MQn, and the input terminal MINn is connected to the output terminal MQn.

Namely, if the scan enable signal SCANEN of the hold circuit is set active and the digital enable signal DIGITALEN is set active, the n-bit display data is serially outputted from the output terminal LQn of the hold circuit 10, and the n-bit display data is serially outputted from each of the output terminals MQ1 to MQn of the mode selector 60.

The level interface 30 of FIG. 7, upon receiving the n-bit display data from the mode selector 60, makes level adjustment of a signal level fit for the D/A converter 20 in the later stage and outputs it to the D/A converter 20. The level interface 30 of FIG. 7 receives the n-bit display data through respective wiring of separate systems from each of the output terminals MQ1 to MQn of the mode selector 60.

Specifically, the level interface 30, for example, applies level adjustment to an output of the output terminal MQ1 of the mode selector 60 and outputs it to the input terminal DAIN1 of the D/A converter 20. Likewise, the level interface 30 applies level adjustment to an output of each of the output terminal MQ2 to MQn and outputs it to each of the input terminals DAIN2 to DAINn of the D/A converter 20.

Namely, if the scan enable signal SCANEN of the hold circuit is set non-active and the digital enable signal DIGITALEN is set non-active, the n-bit display data is outputted from each of the output terminals LQ1 to LQn of the hold circuit 10, and a signal corresponding to each bit data of the n-bit display data is inputted into each of the input terminals DAIN1 to DAINn of the D/A converter 20 through the mode selector 60 and the level interface 30.

Specifically, for example, a signal equivalent to the first bit data of the n-bit display data is inputted into the input terminal DAIN1, and for example, a signal equivalent to the second bit data of the n-bit display data is inputted into the input terminal DAIN2. Likewise, a signal equivalent to the n-th bit data of the n-bit display data is inputted into the input terminal DAINn.

Conversely, if the scan enable signal SCANEN of the hold circuit is set active and the digital enable signal DIGITALEN is set active, the n-bit display data is serially outputted from the output terminal LQn of the hold circuit 10, and the n-bit display data is serially inputted into each of the input terminals DAIN1 to DAINn of the D/A converter 20 through the mode selector 60 and the level interface 30.

Specifically, for example, a signal equivalent to each bit data, for example, from the n-th bit to the first bit, successively, of the n-bit display data is inputted as serial data into each of the input terminals DAIN1 to DAINn.

Namely, a common signal is inputted into each of the input terminals DAIN1 to DAINn of the D/A converter 20. In other words, in this case, since a voltage of the same high level or low level is all inputted into each of the input terminals DAIN1 to DAINn in the D/A converter 20, D/A conversion is carried out based thereon, outputting two types of voltage of high level or low level from the output terminal DAQ. Note that the voltage VDH is supplied to the D/A converter 20. But it is not limited to this.

It should be noted that in the embodiment, the level interface may be omitted and that each of the output terminals MQ1 to MQn may be arranged to be connected to each of the input terminals DAIN1 to DAINn of the D/A converter 20.

The buffer circuit 40, upon receiving the gray scale voltage outputted from the output terminal DAQ of the D/A converter 20, outputs it to the drive voltage output terminal VOUT.

In the test mode, the digital enable signal DIGITALEN is set active and the scan enable signal SCANEN is set active for a fixed period. In this case, the n-bit display data serially outputted from the output terminal LQn of the hold circuit 10 is inputted as serial data into each of the input terminals DAIN1 to DAINn of the D/A converter 20 through the mode selector 60 and the level inter face 30.

Specifically, for example, a signal equivalent to the n-th bit data of the n-bit display data is inputted into each of the input terminals DAIN1 to DAINn of the D/A converter 20. At this time, the same signal is inputted into each of the input terminals DAIN1 to DAINn of the D/A converter 20. If the signal equivalent to the n-th bit data is high level, since the high level signal is inputted into each of the input terminals DAIN1 to DAINn, a high level voltage is outputted from an output terminal DAQ of the D/A converter 20. Conversely, if the signal equivalent to the n-bit data is low level, a low level voltage is outputted from the output terminal DAQ of the D/A converter 20.

Since the signals equivalent to the n-th to the first bit data of the n-bit display data are successively inputted into each of the input terminals DAIN1 to DAINn of the D/A converter 20, the n-bit display data is serially outputted from the output terminal DAQ of the D/A converter 20.

Mode Selector

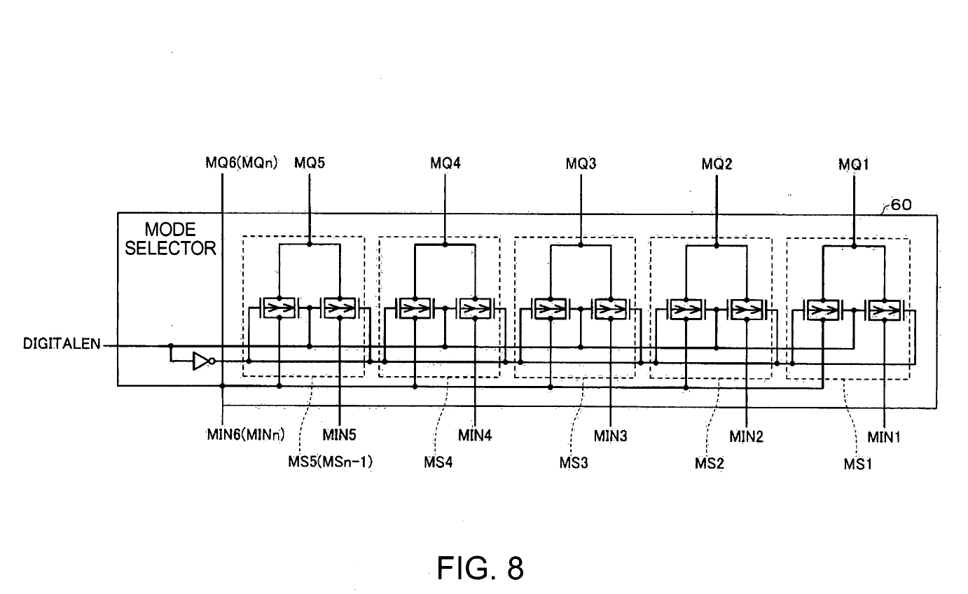

A construction example of the mode selector 60 is shown in FIG. 8. The mode selector 60 includes switch circuits MS1 to MSn−1 for a first to a (n−1)-th mode selectors. Further, a switch circuit MSk for a k-th mode selector of the switch circuits MS1 to MSn−1 for the first to the (n−1)-th mode selectors connects either an input terminal MINk or the input terminal MINn to an output terminal MQk of the mode selector 60 based on the digital enable signal DIGITALEN.

For example, if the digital enable signal DIGITALEN is set active, the input terminal MINn of the mode selector 60 is connected to the output terminal MQk of the mode selector 60. Further, if the digital enable signal DIGITALEN is set non-active, the input terminal MINk is connected to the output terminal MQ.

Specifically, if the digital enable signal DIGITALEN is set active, for example, the mode selector switch circuit MS1 connects the input terminal MIN6 (MINn) to the output terminal MQ1, and for example, the mode selector switch circuit MS5 connects the input terminal MIN6 (MINn) to the output terminal MQ5.

Further, if the digital enable signal DIGITALEN is set active, for example, the mode selector switch circuit MS1 connects the input terminal MIN1 to the output terminal MQ1, and for example, the mode selector switch circuit MS5 connects the input terminal MIN5 to the output terminal MQ5. Note that the input terminal MIN6 (MINn) is connected to the output terminal MQ6 (MQn).

Operation

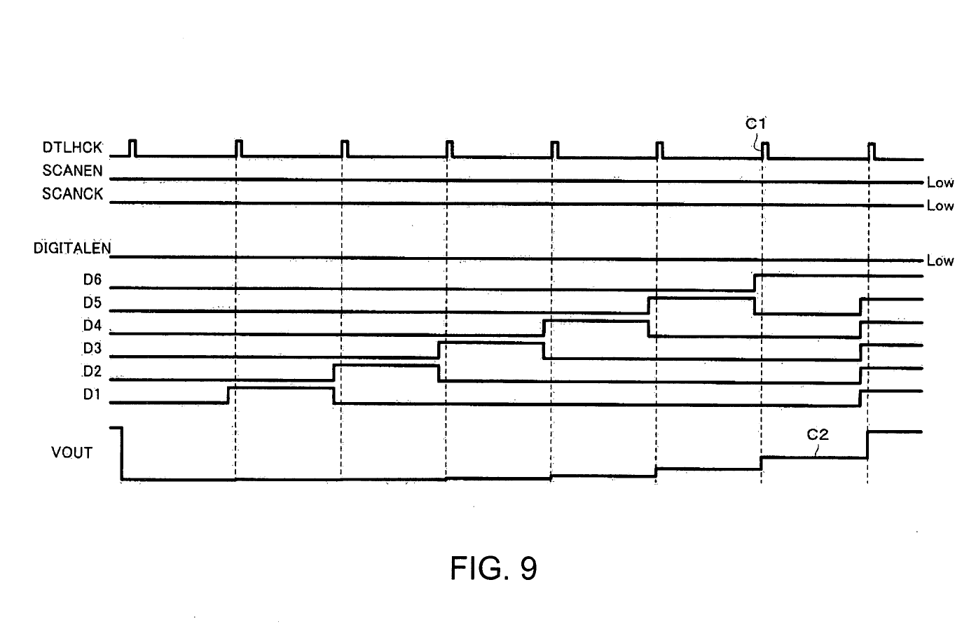

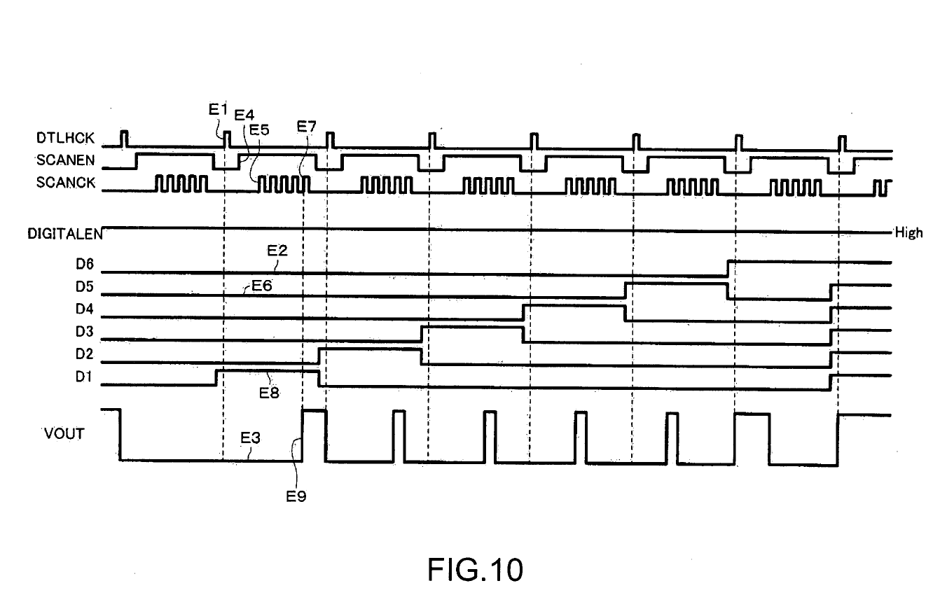

Operation of the display driver 110 of the embodiment will be described by referring to timing charts in FIG. 9 and FIG. 10. FIG. 9 is a timing chart showing operation in the normal operation mode. In the normal operation mode, the scan enable signal SCANEN is set non-active. Further, the digital output enable signal DIGITALEN is set non-active (for example, low level).

In the same way as shown in FIG. 4 which indicates operation of the display driver 100 according to the first embodiment, 6-bit display data is inputted into the D/A converter 20 based on the clock DTLHCK. The D/A converter 20 subjects the inputted display data to D/A conversion and outputs the data. By this operation, the drive voltage is outputted from the drive voltage output terminal VOUT of the output selector 50.

For example, when the clock DTLHCK starts up at the timing shown in C1, the first to the fifth bit data D1 to D5 are low level and the sixth bit data D6 is high level, hence, the drive voltage as shown in C2 is outputted. In this manner, in the normal operation mode. The drive voltage corresponding to a value of the display data is outputted from the drive voltage output terminal VOUT of the output selector 50.

Next, operation of the display driver 110 in the test mode will be described referring to FIG. 10. In the test mode conducting an inspection of the display driver 10, the digital enable signal DIGITALEN inputted into the mode selector 60 is set active. Note that the clock DTLHCK, the scan clock SCANCK and the scan enable signal SCANEN are shown in the same way as FIG. 5.

For example, when the clock DTLHCK starts up at the timing shown in E1, the sixth bit data D6 is inputted into each of the input terminals DAINI1 to DAINIn of the D/A converter 20 through the mode selector 60. In this case, as shown in E2, since the data D6 is low level as presented in E2, a low level voltage is inputted into each of the input terminals DAINI1 to DAINIn of the D/A converter 20, and a low level voltage is outputted from the output terminal DAQ of the D/A converter 20.

Namely, as shown in E3, a low level voltage is outputted from the drive voltage output terminal VOUT. When the scan enable signal SCANEN is set high level at the timing shown in E4, corresponding to the scan clock SCANCK, the fifth to the first bit data D5 to D1 are successively outputted from the output terminal LQn of the hold circuit 10.

For example, when the scan clock SCANCK starts up at a timing shown in E5, the fifth bit data D5 is outputted from the output terminal LQn of the hold circuit 10 to the mode selector 60. At this time, since the data D5 is a low level voltage as presented in E6, a low level voltage is inputted into each of the input terminals DAINI1 to DAINIn of the D/A converter 20. Namely, since the low level voltage is outputted from the output terminal DAQ of the D/A converter 20, the output of the drive voltage output terminal VOUT remains unchanged from the low level state.

Thereafter, in response to the start up of the scan clock SCANCK, each of the fourth to the first bit data D4 to D1 is successively inputted into the D/A converter 20 through the mode selector 60. For example, when the scan clock SCANCK starts up at the E7 timing, the first bit data D1 is inputted into the mode selector 60. At this time, the data D1 is a high level voltage as E8 shows; a high level voltage is inputted into each of the input terminals DAINI1 to DAINIn of the D/A converter 20 through the mode selector 60. By this operation, the high level voltage is outputted from the output terminal DAQ of the D/A converter DAQ, and as shown in E9, the high level voltage is outputted from the drive voltage output terminal VOUT.

In the same way as FIG. 5, in the embodiment, too, by detecting a pulse outputted from the drive voltage output terminal VOUT, it is possible to detect what kind of data each bit of the 6-bit data represents. Namely, in the test mode, it is possible to acquire the content of the display data digitally from the drive voltage output terminal VOUT.

As referenced above, in the test mode, the 6-bit display data stored in the hold circuit 10 is outputted from the drive voltage output terminal VOUT as digital serial data. Now, when inspecting the display driver 110, it is also possible to conduct inspection using the same method as the display driver 100. For example, an inspection flow shown in FIG. 6, is applicable as well to the display driver 110 according to the second embodiment.

Comparative Examples and Effects

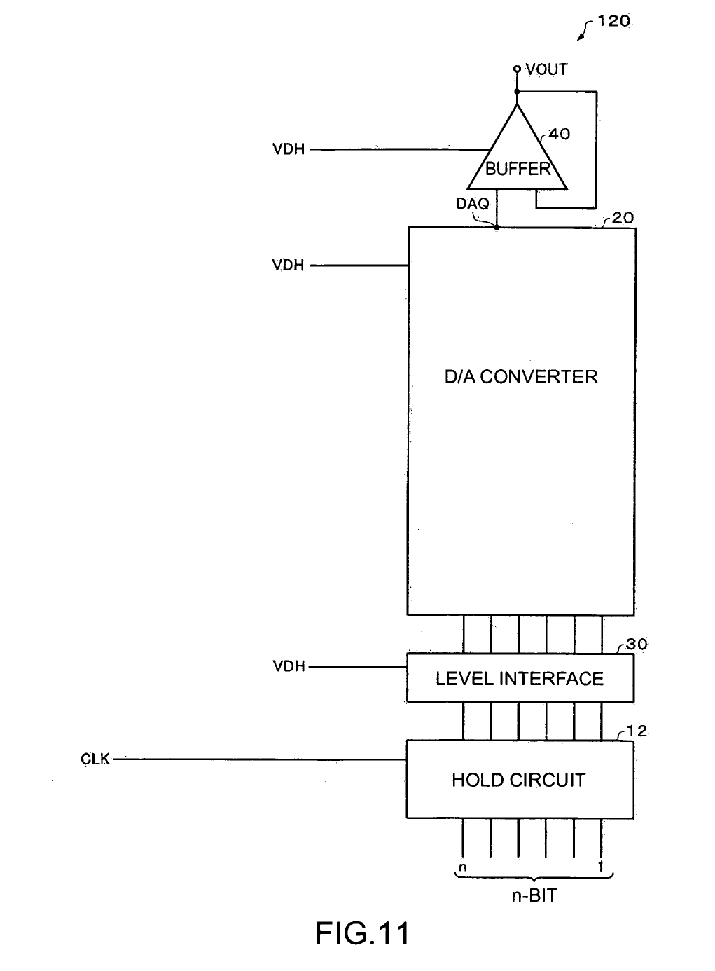

FIG. 11 is a diagram showing a comparative example of the display driver according to the first embodiment and the second embodiment. The display driver 120 of the comparative example includes a hold circuit 12, a D/A converter 20, a level interface 30, and a buffer 40. But it is not limited to this.

For example, the display driver 120 may be of construction which omits the level interface 30. The hold circuit 12, in response to a clock CLK, latches and outputs the n-bit display data. The outputted n-bit display data is, for example, inputted into the D/A converter 20 through the level interface 30. The D/A converter 20 subjects the inputted display data to D/A conversion and outputs a gray scale voltage from the output terminal DAQ. The gray scale voltage is outputted from the drive voltage output terminal VOUT through the buffer 40.

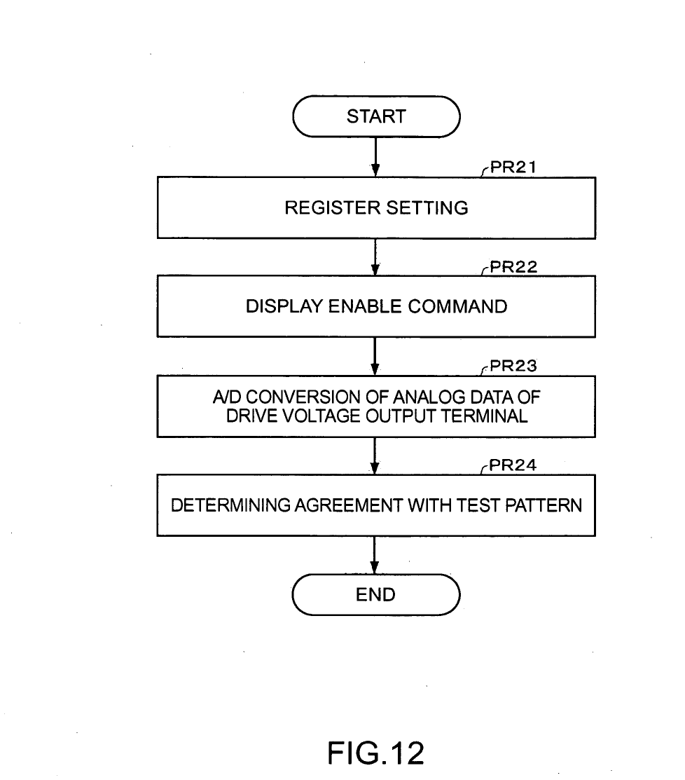

An example of an inspection flow when inspecting the display driver 120 of a construction referenced above is shown in FIG. 12. In processing PR21, various settings of an internal register of the display driver 120 are carried out. Next, in processing PR22, the display enable command is sent out to the display driver 120. By means of the display enable command, for example, the display data of each pixel is outputted from the display memory, which stores the display data, to the hold circuit 12 of the display driver 120. This enables the drive voltage to be outputted from the drive voltage output terminal VOUT of the display driver 120.

Next, in processing PR 23, this drive voltage is subjected to A/D conversion to inspect the drive voltage to be outputted from the drive voltage output terminal VOUT of the display driver 120 through processing PR22.

Next, in processing PR24, there is made a comparison between the digital data after the A/D conversion in processing PR23 and a test pattern of the display data which was set in advance, and the agreement is determined. Through this determination of the agreement, evaluation is made as to whether or not the display driver 100 operates, for example, according to the design.

And yet, there are several problems according to the method described above. For example, according to the method, it is necessary to subject the drive voltage, which is outputted from the drive voltage output terminal VOUT of the display driver 120, to A/D conversion, and accuracy of the A/D conversion is required.

Further, in the inspection, the A/D conversion is needed per pixel, thus preventing inspection time from being shortened. Moreover, the higher the degree of gray scale becomes, the more accuracy is required of the A/D conversion with respect to the drive voltage. In regard to the display drivers driving a display panel of high resolution and high gray scale in recent years, it is difficult to acquire accurate data even by subjecting the drive voltage to A/D conversion, hence, raising the accuracy of the inspection is difficult.

Consequently, these are factors detrimental to reducing the manufacturing cost of products and to providing display drivers of high quality.

On the other hand, the display driver 100 according to the first embodiment and the display driver 110 according to the second embodiment are able to resolve the problems. The display drivers 100 and 110 can both set the test mode.

When this test mode is set, from the drive voltage output terminal VOUT of the display drivers 100 and 110, the n-bit display data is outputted as digital data. As a result, when determining the agreement between the display data pre-set as the test pattern and the display data to be outputted from the drive voltage output terminal VOUT, the agreement can be determined through comparison of the digital data. Therefore, the inspection of high accuracy is possible.

Furthermore, even if the display drivers 100 and 110 perform a high gray scale display to compare the digital data, the digital data values only increase, acting in no way as a factor of reducing the inspection accuracy in the inspection. Namely, even if the display drivers 100 and 110 are corresponding to the high gray scale display, highly accurate inspection is possible.

As described above, the embodiments of the invention have been described in detail. Many modifications can be made without departing from the effects of the invention. Accordingly, such modifications and alterations are all included within the scope of the invention. For example, in the specification and the drawings, terms listed at least once, together with terms having a broad meaning or having the same meaning but different terms can be replaced with the different terms in any part of the specification or the drawings.

What is claimed is:

1. A display driver comprising:
a hold circuit holding and outputting display data of at least one pixel;
a D/A converter carrying out D/A conversion of display data outputted from the hold circuit; and
an output selector in which a gray scale voltage based on an output of the D/A converter is inputted into a first input terminal thereof and outputs a drive voltage to a drive voltage output terminal, wherein the hold circuit includes first to n-th latch circuits (n being a natural number greater than 2), whereby, in a normal operation mode, the hold circuit outputs data latched in the first to the n-th latch circuits to the D/A converter, while, in a test mode for carrying out an inspection of the display data, the hold circuit serially outputs data latched in the first to the n-th latch circuits as serial output data from the n-th latch circuit; the output selector having a second input terminal receiving the serial output data outputted from the n-th latch circuit, outputting to the drive voltage output terminal the gray scale voltage inputted into the first input terminal in the normal operation mode, while outputting to the drive voltage output terminal, in the test mode, a voltage based on the serial output data inputted from the hold circuit into the second input terminal.

2. The display driver according to claim 1, wherein the output selector outputs a gray scale voltage, which is inputted into the first input terminal, to the drive voltage output terminal, once an analog output enable signal is set active, and a voltage based on the voltage inputted into the second input terminal is outputted to the drive voltage output terminal, once the digital output enable signal is set active; in the normal operation mode, the analog output enable signal is set active and the digital output enable signal is set non-active, while in the test mode to conduct the display data inspection, the analog output enable signal is set non-active and the digital output enable signal is set active.

3. The display driver according to claim 2, wherein the output selector includes:
a p-type transistor set up between an output node connected to the drive voltage output terminal and a first power source; and
an n-type transistor set up between a second power source at a lower voltage than the first power source and the output node, wherein, if the digital output enable signal is set active, upon inputting a first level signal in the second input terminal, the p-type transistor assumes an on state; if the n-type transistor assumes an off state so that through the output node, the drive voltage output terminal is electrically connected to the first power source such that if a second level signal different from the first level is inputted into the second input terminal, the p-type transistor assumes the off state and the n-type transistor assumes the on state, so that the drive voltage output terminal is electrically connected to the second power source through the output node.

4. The display driver according to claim 1, wherein a digital signal output line is set up between the output selector and an output terminal of the n-th latch circuit, the first to the n-th latch circuits of the hold circuit storing data of first to n-th bit of the display data, and the hold circuit outputting to the output selector the display data latched in the first to the n-th latch circuits based on a scan enable signal through the D/A converter or the digital signal output line, whereupon data of the first to the n-th bit held in the first to the n-th latch circuits are outputted to the D/A converter through respectively different output lines if the scan enable signal is set non-active, while the data of the first to the n-th bit is outputted, as the serial output data, from the output terminal of the n-th latch circuit to the digital signal output line if the scan enable signal is set active.

5. The display driver according to claim 4, wherein the hold circuit further includes:
first to (n−1)-th scan switch circuits; a k-th (k being a natural number greater than 1) scan switch circuit of the first to the (n−1)-th scan switch circuits receiving an output from the k-th latch circuit of the first to the nth latch circuits as well as data of the (k+1)-th bit of the display data, whereupon, if the scan enable signal is set active, an output of the k-th latch circuit is outputted to the (k+1)-th latch circuit, while, if the scan enable signal is set non-active, the (k+1) bit data is outputted to the (k+1)-th latch circuit.

6. The display driver according to claim 1, wherein if a voltage outputted from the drive voltage output terminal is made to correspond to a digital gray scale display of the display panel in the normal operation mode, the hold circuit outputs the data latched in the first to the n-th latch circuits to the D/A converter, while from the drive voltage output terminal, the output selector outputs a voltage based on the n-th bit data, which was supplied to the second input terminal through the digital output line, from the n-th latch circuit.

7. The display driver according to claim 4, wherein if the voltage outputted from the drive voltage output terminal is made to correspond to the digital gray scale display of the display panel in the normal operation mode, the digital input enable signal to be inputted into the output selector is set active, while the output selector outputs the voltage based on the n-th bit data, which was supplied from the n-th latch circuit through the digital output line, from the drive voltage output terminal if the scan enable signal of the hold circuit is set non-active.

8. A display driver, comprising:
a hold circuit holding and outputting display data of at least one-pixel;
a mode selector, upon receipt of display data outputted from the hold circuit, outputting by changing over an output channel of the display data corresponding to a normal operation mode or a test mode for inspecting the display data; and
a D/A converter equipped with first to n-th (n being a natural number more 2) D/A converter input terminals, to which the first to the n-th bit data of the display data outputted from the mode selector are inputted, D/A converting the display data inputted through first to n-th D/A converter input terminals, wherein the hold circuit includes the first to the n-th (n being a natural number greater than 2) latch circuits storing the first to the n-th bit data, whereupon the hold circuit, in the normal operation mode, outputs to the mode selector the data of the first to the n-th bit data latched by the first to the n-th latch circuits through a different output line per latch circuit, while the hold circuit, in the test mode for inspecting the display data, serially is outputting to the mode selector the first to the n-th bit data latched by the first to the n-th latch circuits, as serial data, from the nth latch circuit and wherein the mode selector, in the normal operation mode, outputs the first to the n-th bit data of the display data, which were outputted from the hold circuit, to the first to the n-th D/A converter input terminals of the D/A converter, and, in the test mode, outputs the serial output data outputted from the hold circuit, to the first to the n-th D/A converter input terminals of the D/A converter.

9. The display driver according to claim 8, wherein the mode selector includes the first to the n-th mode selector input terminals, to which the display data is inputted from the hold circuit, and the first to the n-th mode selector output terminals to output the display data to the first to the n-th D/A converter input terminals of the D/A converter, whereas, in the test mode for inspecting the display data, the mode selector, upon receiving the digital output enable signal which is set active, electrically connects the n-th mode selector input terminal to receive an output of the n-th latch circuit of the hold circuit of the first to the n-th mode selector input terminals to the first to the n-th mode selector output terminals, while the serial output data from the n-th latch circuit are outputted to the first to the n-th mode selector output terminals.

10. The display driver according to claim 9, wherein the mode selector includes first to (n−1)-th mode selector switch circuits, whereas the k-th mode selector switch circuit of the first to the (n−1)-th mode selector switch circuits, upon receiving an output from the k-th latch circuit connected to the k-th mode selector input circuit and an output from the n-th latch circuit connected to the n-th mode selector input terminal, outputs the output from the n-th latch circuit to the k-th mode selector output terminal if the digital output enable signal is set active, while outputting the output from the k-th latch circuit to the k-th mode selector output terminal if the digital output enable signal is set non-active.

11. The display driver according to claim 8, wherein the hold circuit outputs to the mode selector the display data latched in the first to the n-th latch circuits based on the scan enable signal, outputs to the mode selector the first to the n-th bit data held in the first to the n-th latch circuits through respectively different output lines if the scan enable signal is set non-active, and outputs to the mode selector the first to the n-th bit data from the n-th latch circuit output terminal as serial output data if the scan enable signal is set active.

12. The display driver according to claim 11, wherein the hold circuit outputs to the mode selector the display data latched in the first to the n-th latch circuits based on the scan enable signal, outputting to the mode selector the first to the n-th bit data held in the first to the n-th latch circuits through respectively different output lines, if the scan enable signal is set non-active, while outputting to the mode selector the first to the n-th bit data from the n-th latch circuit output terminal as serial output data.

13. The display driver according to claim 11, wherein the hold circuit further includes first to (n−1)-th scan switch circuits, wherein a k-th (k being a natural number greater than 1) scan switch circuit of the first to the n-th scan switch circuits, upon receiving an output from the k-th latch circuit of the first to the n-th latch circuits and the (k+1)-th bit data of the display data, outputs the k-th latch circuit to the (k+1)-th latch circuit if the scan enable signal is set active, while outputting the (k+1)-th bit data to the (k+1)-th latch circuit if the scan enable signal is set non-active.
